(19) United States
(12) Patent Application Publication
(10) Pub. No.: US 2022/0389251 A1
(43) Pub. Date: Dec. 8, 2022

(54) PHOTOPOLYMERIZABLE COMPOSITION, OPTICAL MEMBER AND DISPLAY DEVICE FORMED THEREFROM

(71) Applicant: DONGJIN SEMICHEM CO., LTD., Incheon (KR)

(72) Inventors: Sang-Hoon LEE, Hwaseong-si (KR); Hyoc-Min YOUN, Hwaseong-si (KR); Tai Hoon YEO, Hwaseong-si (KR); Jonghyuk PARK, Hwaseong-si (KR)

(21) Appl. No.: 17/890,019

(22) Filed: Aug. 17, 2022

Related U.S. Application Data
(63) Continuation of application No. PCT/KR2021/002049, filed on Feb. 18, 2021.

(30) Foreign Application Priority Data
Feb. 20, 2020 (KR) 10-2020-0020844
Feb. 17, 2021 (KR) 10-2021-0020811

(51) Int. Cl. C09D 11/322; C09D 11/101; C09D 11/107; C09D 11/037; G02B 1/04

(52) U.S. Cl. CPC C09D 11/322; C09D 11/101; C09D 11/107; C09D 11/037; G02B 1/04

(57) ABSTRACT

The present disclosure relates to a photopolymerizable composition which enables the formation of an optical member that exhibits improved optical properties, including excellent light transmittance, low haze, and high refractive index, an optical member and a display device formed therefrom. The photopolymerizable composition includes at least one olefinic monomer having a photocurable functional group, metal oxide particles, an amine compound having an amine group and a photocurable functional group, and a photopolymerization initiator.

### CROSS-REFERENCE TO RELATED APPLICATION

The present application is a Continuation of PCT/KR2021/002049 filed on Feb. 18, 2021, which claims priority to Korean Application No. 10-2020-0020844 filed on Feb. 20, 2020, and Korean Application No. 10-2021-0020811 filed on Feb. 17, 2021. The aforementioned applications are incorporated herein by reference in their entireties.

### TECHNICAL FIELD

The present disclosure relates to a photopolymerizable composition which allows the formation of an optical member exhibiting improved optical properties including excellent light transmittance, low haze and high refractive index, an optical member and a display device formed therefrom.

### BACKGROUND ART

In the case of a transmissive optical film having a structured prism, the luminance increase rate changes depending on the refractive index of the resin constituting the prism structure. Generally, as the refractive index of the resin constituting the prism increases, the luminance increase rate increases. Therefore, research and development have been advanced in the direction of increasing the refractive index of the resin.

However, generally, the resin constituting the prism is formed of organic compounds, and the upper limit of the refractive index range that can be adjusted with organic compounds is known to be about 1.65 in theory. Thus, the adjustable refractive index range is narrow compared to inorganic compounds. Further, when trying to increase the refractive index of a resin formed of organic compounds, it shows problems such as an increase in the viscosity of the monomer composition, a decrease in the processability, or a decrease in the UV stability, and thus is subject to many restrictions.

Moreover, when the resin and the optical film are formed by using an existing general photopolymerizable composition as a monomer composition, in many cases, surface curing would not occur sufficiently due to the influence of oxygen in the air and the like in the process of photocuring the monomer composition. As a result, the resin and the optical film have a problem that haze increases, and light transmittance such as ultraviolet transmittance and visibility are lowered. In this regard, a method of performing the curing process in an inert gas atmosphere such as nitrogen has been considered, but this may lead to a significant increase in the production cost.

### SUMMARY

Therefore, an object of the present disclosure is to provide a photopolymerizable composition which enables the formation of an optical member that suppresses an increase in haze or the like during the curing process and exhibits improved optical properties, including excellent light transmittance, low haze, and high refractive index.

Another object of the present disclosure is to provide an optical member formed of the photopolymerizable composition and exhibiting improved optical properties including excellent light transmittance, low haze and high refractive index.

Yet another object of the present disclosure is to provide a display device including the optical member.

According to an aspect of the present disclosure, there is provided a photopolymerizable composition comprising:

at least one olefinic monomer having a photocurable functional group;

metal oxide particles;

an amine compound having an amine group and a photocurable functional group; and

a photopolymerization initiator.

According to another aspect of the present disclosure, there is provided an optical member comprising: a substrate; and a cured film containing a cured product of the photopolymerizable composition. In such an optical member, the cured product may include a polymer that contains a unit in which the photocurable functional groups of the olefinic monomer and the amine compound are crosslinked, and a dispersant dispersed on the polymer, and a metal oxide.

According to yet another aspect of the present disclosure, there is provided a display device comprising the optical member.

The photopolymerizable composition described herein enables the formation of a cured film satisfying a high refractive index and an optical member including the film. Further, by the action of the amine compound contained in the photopolymerizable composition, the problem of reduced surface curability due to the influence of oxygen can be greatly reduced, and as a result, it becomes possible to form an optical member exhibiting low haze, excellent light transmittance such as ultraviolet transmittance, and high visibility.

In addition, in the curing process of the photopolymerizable composition, the application of a nitrogen atmosphere or the like is not necessary, so that the economic efficiency of the overall process can also be greatly improved.

Therefore, the optical member formed with the photopolymerizable composition exhibits low haze, high refractive index, excellent light transmittance, visibility, and the like while having a low production cost, and thus can greatly contribute to the improvement of the characteristics of the display device.

### DETAILED DESCRIPTION

Hereinafter, embodiments of the present disclosure will be described in more detail. It will be understood that words or terms used in the specification and the appended claims shall not be interpreted as the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention.

The term “including” or “comprising” as used herein specifies a specific feature, region, integer, step, action, element and/or component, but does not exclude the presence or addition of a different specific feature, region, integer, step, action, element, and/or component.

The (meth)acrylate as used herein includes both acrylate and methacrylate.

Hereinbelow, various embodiments of the present disclosure will be described in detail so that those skilled in the art can easily implement them. The embodiments can be modified in various different ways, and is not limited to the specific embodiments set forth herein.

According to an embodiment of the disclosure, there is provided a photopolymerizable composition comprising:

at least one olefinic monomer having a photocurable functional group;

metal oxide particles;

an amine compound having an amine group and a photocurable functional group; and

a photopolymerization initiator.

The photopolymerizable composition of an embodiment includes the olefinic monomer together with the metal oxide particles. By using such an olefinic monomer, the photopolymerizable composition has excellent processability such as application and film formation. Further, as the olefinic monomer is used together with metal oxide particles and the like, it enables the formation of a cured film satisfying a high refractive index required for an optical member, such as a transmissive optical film, and an optical member including the film.

And, it was confirmed that the problem of deterioration of the surface curability due to the influence of oxygen can be greatly reduced by the action of the predetermined amine compound contained in the photopolymerizable composition. For example, during the curing process, as the amine group of the amine compound captures oxygen radicals in the air while the photocurable functional group of the amine compound participates in the curing reaction together with the olefinic monomer, the reactivity of the polymerization initiator can be further increased.

Therefore, when the photopolymerizable composition of an embodiment is photocured to form a cured film and an optical member, a high degree of surface curing can be achieved even in an air atmosphere, so that the cured film can exhibit low haze, excellent light transmittance such as UV transmittance, and high visibility. In addition, in the curing process of the photopolymerizable composition, it is not necessary to apply a nitrogen atmosphere or the like, so that the economic efficiency of the overall process can also be greatly improved.

Therefore, when the photopolymerizable composition is used, the formation of the optical member showing low haze, high refractive index, excellent light transmission and visibility, etc. while having a low production cost, becomes possible, which can greatly contribute to the improvement of the characteristics of the display device.

Specifically, each component used in the photopolymerizable composition will be described below.

The photopolymerizable composition of an embodiment is a basic monomer for forming a cured film matrix, and includes at least one olefinic monomer having a photocurable functional group.

In the olefinic monomer, the photocurable functional group is crosslinked and polymerized via a photopolymerization initiator by the photocuring process described later to form a basic resin constituting a cured film.

In an exemplary embodiment, the olefinic monomer may have an absolute viscosity (measured at 25° C.) of 1 cP to 30 cP, or 2 cP to 25 cP. As the olefinic monomer satisfies this absolute viscosity range, the composition of the embodiment may have an absolute viscosity suitable for an inkjet application process, for example, an absolute viscosity of 5 to 30 cP. Therefore, the composition of the embodiment including the same enables the formation of a cured film which is excellent in the processability by an inkjet application process or the like, and excellent in heat resistance and mechanical properties and has good coating film properties. Further, the cured film and the optical member formed of the composition according to the embodiment may have a high refractive index of 1.6 or more due to the interaction between the olefinic monomer and the metal oxide particles described later.

If the absolute viscosity of the olefinic monomer is less than 1 cP, it may cause a decrease in heat resistance or mechanical properties of the photopolymerizable composition, and for example, in an inkjet application process, or the like, the inkjet nozzle can be dried, causing defective discharge of the composition. Further, when the absolute viscosity of the olefinic monomer exceeds 30 cP, the inkjet may not be discharged or the discharge amount may be reduced, which may make the progress of the inkjet application process very difficult.

For reference, the viscosity of the olefinic monomer or the photopolymerizable composition described herein means an absolute viscosity value measured at 25° C., and such absolute viscosity can be measured using a viscometer well known in the art, for example, a Brookfield viscometer.

Meanwhile, examples of the above-mentioned olefinic monomer are not particularly limited, and an olefinic monomer having a photocurable functional group including a (meth)acrylate group can be appropriately used in consideration of appropriate viscosity characteristics, curing characteristics, and the like.

Examples of such an olefinic monomer may include a mono (meth)acrylate-based compound or a di(meth)acrylate-based compound. More specifically, at least one selected from the group consisting of an aliphatic mono(meth)acrylate having 6 to 20 carbon atoms, an alicyclic mono(meth)acrylate having 6 to 30 carbon atoms, an aromatic mono(meth)acrylate having 8 to 30 carbon atoms, an aliphatic di(meth)acrylate having 6 to 30 carbon atoms, an alicyclic di(meth)acrylate having 6 to 40 carbon atoms, and an aromatic di(meth)acrylate having 8 to 40 carbon atoms can be used.

Further, according to a more preferred embodiment, in order to ensure that the monomer composition of the embodiment exhibits viscosity characteristics more suitable for an inkjet application process or the like, and also a cured film formed therefrom can exhibit a high refractive index in a desired range and the like, the olefinic monomer may include at least one selected from the group consisting of a first olefinic monomer having an absolute viscosity (measured at 25° C.) of 1 cP or more and 7 cP or less and a second olefinic monomer having an absolute viscosity (measured at 25° C.) of 8 cP or more and 30 cP or less.

According to the embodiment from the viewpoint of achieving the above-mentioned viscosity characteristics and refractive index, the olefinic monomer may include a first olefinic monomer having a low viscosity and a second olefinic monomer having a high viscosity together. More specifically, the photopolymerizable composition may contain 10 to 90 parts by weight, or 20 to 80 parts by weight of the first olefinic monomer and 10 to 90 parts by weight, or 20 to 80 parts by weight of the second olefinic monomer with respect to 100 parts by weight of the entire olefinic monomer.

As described above, as the olefinic monomer, the low-viscosity first olefinic monomer and the high-viscosity second olefinic monomer are used in combination at a constant ratio, whereby the processability of the photopolymerizable composition including the same due to the inkjet application process and the like is further improved, while the cured film and optical member formed therefrom can exhibit optical properties, such as more improved heat resistance and low haze.

As the first or second olefinic monomer, a compound known to satisfy a certain viscosity can be selected and used in the category of the above-mentioned olefinic monomer without particular limitation.

For example, a specific example of the first olefinic monomer may include at least one selected from the group consisting of benzyl(meth)acrylate, isodecyl(meth)acrylate, lauryl(meth)acrylate, ethoxy ethyl(meth)acrylate, dicyclopentenyl (meth)acrylate, and dicyclopentanyl(meth)acrylate. In addition, various (meth)acrylate-based monomers known to have a low viscosity can be used.

Further, a specific example of the second olefinic monomer may include at least one selected from the group consisting of dicyclopentenyl oxy ethyl(meth)acrylate, phenoxy ethyl(meth)acrylate, phenoxy benzyl(meth)acrylate, isobornyl (meth)acrylate, 1,6-hexanediol di(meth)acrylate, triethylene glycol di(meth)acrylate, tetraethylene glycoldi(meth)acrylate, dipropylene glycol di(meth)acrylate, 2-vinyloxyethoxy ethyl(meth)acrylate and tripropylene glycol di(meth)acrylate, and other various (meth)acrylate-based monomers known to have a high viscosity in the above-described range can be used.

The above-mentioned olefinic monomer may be contained in an amount of 5% by weight to 88% by weight, or 15% by weight to 85% by weight based on 100% by weight of the entire photopolymerizable composition. If the content of the olefinic monomer is excessively low, the uniformity of the metal oxide particles may decrease after the formation of the coating film, and the viscosity may increase, which may make inkjet ejection difficult. Further, when the olefinic content is excessively high, it may be difficult to achieve a high refractive index of the cured film and the optical member.

Meanwhile, the photopolymerizable composition of an embodiment includes metal oxide particles. These metal oxide particles are dispersed on a cured film formed by photocuring the olefinic monomer, which makes it possible to achieve a high refractive index of the cured film and the optical member containing the cured film.

The metal oxide particles have, for example, an average particle size (D50) of 25 to 45 nm, or 30 to 40 nm, based on the secondary particle size in a medium-dispersed state, and oxide particles containing a metal element selected from the group consisting of Zn, Zr, Ti, Hf, and Ce can be used.

Among these, from the viewpoint of achieving a high refractive index, zirconium (Zr) oxide particles can be used more preferably. Further, as the metal oxide particles satisfy the above-mentioned average particle size range, the photopolymerizable composition of the embodiment can be easily adjusted to have a viscosity range suitable for an inkjet application process or the like, while the optical characteristics can be improved, for example, the haze of the cured film becomes lower.

The above-mentioned metal oxide particles may be contained in an amount of 10% by weight to 70% by weight or 10% by weight to 65% by weight based on 100% by weight of the entire photopolymerizable composition. If the content of metal oxide particles is too low, it may be difficult to achieve a high refractive index. On the contrary, if the content thereof is too high, the uniformity of the metal oxide particles may decrease after the formation of the coating film, and the viscosity may increase, which may make inkjet ejection difficult.

Meanwhile, the photopolymerizable composition of an embodiment includes an amine compound having an amine group and a photocurable functional group. In regard to the amine compound, in the process of photocuring the composition of one embodiment to form a cured film and an optical member, the amine group contained therein can capture oxygen radicals and the like in the air to accelerate the reaction of the initiator. Furthermore, the photocurable functional group in the amine compound may participate in a curing reaction together with the monomer to form a crosslink. Due to the action of such an amine compound, the cured film and the optical member formed of the composition of one embodiment can exhibit a high surface curability, whereby excellent optical characteristics such as low haze and improved light transmittance can be exhibited.

As such an amine compound, a functional group capable of forming a crosslinkage between an amine group in the molecule and a photocurable functional group, for example, a photocurable functional group of the above-mentioned monomer can be used. In a more specific embodiment, any compound having a (meth)acrylate group that is the same type of photocurable functional group as the monomer can be used. Further, in order to more effectively capture the oxygen radicals and the like to further increase the degree of surface curing of the cured film, and the like, it is more preferable that the amine compound includes a tertiary or higher amine structure in the molecule.

Specific examples of such amine compounds may include at least one selected from the group consisting of a compound of the following Chemical Formula 1, ethyl dimethylamino benzoate, butoxyethyl dimethylamino benzoate, bis(diethylamino)benzophenone, bis(2-hydroethyl)-toluidine, ethylhexyl-(dimethylamino)benzoate, 2-(dimethylamino)ethyl (meth)acrylate, diethylaminoethyl(meth)acrylate, 2-(diisopropylamino)ethyl (meth)acrylate, 2-(acryloyloxy)ethyl 4-(dimethylamino)benzoate, 2-ethylhexyl 4-(dimethylamino)benzoate, ethyl 2-(dibutylamino)methyl acrylate and 4,4-(oxybis(ethane-2, 1-diyl))bis(oxy)bis(dimethylaniline). In addition, various other compounds having amine groups and photocurable functional groups can also be used.

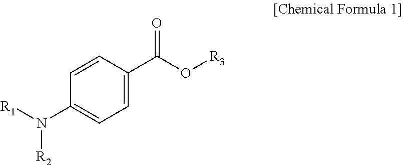

In Chemical Formula 1, R₁ and R₂ each independently represent an alkyl group having 1 to 5 carbon atoms, and R₃ represents an alkyl group having 1 to 20 carbon atoms, an ether group having 1 to 20 carbon atoms, an aryl group, an amine group or a (meth)acrylate group having 6 to 30 carbon atoms.

Further, a commercially available amine-based photocurable compound can also be used as the amine compound, and examples of such a commercialized compound include P115 (manufactured by SK Cytec), MIRAMER AS2010 (manufactured by Miwon Specialty Chemical Co., Ltd.), or MIRAMER AS5142 (manufactured by Miwon Specialty Chemical Co., Ltd.), and the like.

The above-mentioned amine compound may be contained in an amount of 0.1% to 10% by weight, or 0.5% to 9% by weight based on 100% by weight of the entire photopolymerizable composition. If the content of the amine compound is too low, the surface curability may be deteriorated, and the haze of the cured film and the optical member may be increased. On the contrary, if the content thereof is too high, the viscosity of the photopolymerizable composition may be excessively high, so that the processability may be deteriorated, or the refractive index of the cured film or the like may be decreased.

The photopolymerizable composition of the above-mentioned embodiment includes a photopolymerization initiator. The photopolymerization initiator may initiate and accelerate the photocuring reaction of the above-mentioned olefinic monomer and amine compound. Further, the initiation of the photocuring reaction, etc. can be made more effectively by the action of the amine compound.

As the photopolymerization initiator, any initiator known to initiate and accelerate the photocuring reaction of a photocurable functional group such as a (meth)acrylate group can be used.

Examples of such photopolymerization initiator may include at least one selected from the group consisting of triazine-based, benzoin-based, benzophenone-based, imidazole-based, xanthone-based, oxime ester-based, and acetophenone-based compounds. More specific examples of the photopolymerization initiator may include at least one selected from the group consisting of 2,4-bistrichloromethyl-6-p-methoxystyryl-s-triazine, 2-p-methoxystyryl-4,6-bistrichloromethyl-s-triazine, 2,4-trichloromethyl-6-triazine, 2,4-trichloromethyl-4-methylnaphthyl-6-triazine, 2-(o-chlorophenyl)-4,5-diphenyl imidazole dimer, 2-(o-chlorophenyl)-4,5-di(m-methoxyphenyl)imidazole dimer, 2-(o-fluorophenyl)-4,5-diphenyl imidazole dimer, 2-(o-methoxyphenyl)-4,5-diphenyl imidazole dimer, 2-(o-methoxyphenyl)-4,5-diphenyl imidazole dimer, 2,4-di(p-methoxy phenyl)-5-phenyl imidazole dimer, 2-(2,4-dimethoxyphenyl)-4,5-diphenyl imidazole dimer, 2-(p-methylmercaptophenyl)-4,5-diphenyl imidazole dimer, [1-[9-ethyl-6-(2-methylbenzoyl)-9H-carbazolyl-3-yl]-1-(O-acetyloxime), benzophenone, p-(diethyl amino)benzophenone, 2,2-dichloro-4-phenoxyacetophenone, 2,2-diethoxyacetophenone, 2-dodecylthioxanthone, 2,4-dimethylthioxanthone, 2,4-diethylthioxanthone, 2,2-bis-2-chlorophenyl-4,5,4,5-tetraphenyl-2-1,2-biimidazole, (E)-2-(acetoxyimino)-1-(9,9-diethyl-9H-fluorene-2-yl)butanone, (E)-1-(9,9-dibutyl-7-nitro-9H-fluorene-2-yl)ethanone 0-acetyloxime, (Z)-2-(acetoxyimino)-1-(9,9-diethyl-9H-fluorene-2-yl)propanone, Irgacure 369, Irgacure 651, Irgacure 907, Darocur TPO, Irgacure 819, OXE-01, OXE-02, OXE-03, OXE-04, N-1919, NCI-831 and NCI-930 (available from ADEKA). In addition, a photoinitiator known in the art can be widely used without particular limitation.

The above-mentioned photopolymerization initiator can be contained in an amount of 0.1% by weight to 10% by weight, or 0.5% by weight to 7% by weight based on 100% by weight of the entire photopolymerizable composition. If the content of the photopolymerization initiator is too low, photocuring may not occur properly. On the contrary, if the content is too high, the integrated transmittance of the cured film or the like may be decreased to, for example, 90% or less.

The photopolymerizable composition of one embodiment may further include a dispersant in addition to each component described above. Such a dispersant can be included in the above-mentioned photopolymerizable composition to improve the dispersion stability of other components such as metal oxide particles.

The type of such dispersant is not particularly limited, and any dispersant known to be usable for improving dispersibility of metal oxide particles and the like can be used. Examples of such a dispersant include at least one selected from the group consisting of an acryl-based dispersant, an epoxy-based dispersant, and a silicone-based dispersant.

The dispersant may be contained in an amount of 0.1% to 30% by weight, or 0.5% to 20% by weight, based on 100% by weight of the entire photopolymerizable composition. Depending on the content of the dispersant, the metal oxide particles and the like can be uniformly dispersed, so that a desired refractive index range of the cured film can be more effectively achieved. However, if the content of the dispersant is excessively high, the viscosity of the photopolymerizable composition may increase and the processability may decrease.

Meanwhile, the photopolymerizable composition of an embodiment may further include other additives in consideration of additional required physical characteristics or processability. As a non-limiting example, when the photopolymerizable composition is applied, an additive capable of improving the uniformity or surface smoothness of the film thickness or improving the adhesion between the photopolymerizable composition and the substrate can be further included. Such additives may include at least one selected from a surfactant, a silane-based coupling agent, and a crosslinking agent compound.

For example, based on 100 parts by weight of the total content of the photopolymerizable composition, 0.1 parts by weight to 30 parts by weight of a melamine crosslinking agent compound is included, or 0.1 parts by weight to 30 parts by weight of a silane-based coupling agent is included, or 0.1 parts by weight to 5 parts by weight of a surfactant may be further included. Among them, two or more kinds of additives can be contained in combination.

Further, the composition of the embodiment described above may be prepared in a solvent-free type that does not include a separate solvent or liquid medium. The composition acts as a medium for dissolving or dispersing other components such as the olefinic monomer, so that production of such a solvent-free type becomes possible. Thereby, since the drying process for removing the solvent or the like after application can be omitted or minimized, the processability using the composition of the embodiment can be further improved.

The photopolymerizable composition of an embodiment including each of the above-mentioned components may have an absolute viscosity (measured at 25° C.) of 5 to 30 cP or 11 cP to 30 cP. The absolute viscosity can be measured using a well-known viscosity measuring instrument, for example, a Brookfield viscosity measuring instrument, in the same manner as in the above-described olefinic monomer. As the photopolymerizable composition of one embodiment satisfies this viscosity range, not only it is excellent in processability by the inkjet application process or the like while enabling the formation of a cured film having excellent heat resistance and mechanical properties, but also it is possible to form a good coating film by the inkjet application process.

If the viscosity of the final composition is too low, nozzle drying and clogging may cause deterioration of discharge characteristics. Moreover, when the viscosity of a composition is too high, discharge amount decreases and a pattern and surface formation do not occur.

Meanwhile, according to another embodiment of the invention, a cured film including a cured product of the above-mentioned photopolymerizable composition and an optical member including the same are provided. Such an optical member may include a substrate; and the cured film formed on the substrate. Further, as the cured film is formed by photocuring after the photopolymerizable composition of an embodiment is an inkjet application process, and is applied on a substrate, it can mainly include a polymer containing a unit in which the photocurable functional groups of the olefinic monomer and the amine compound are crosslinked, and a cured product comprising a dispersant and a metal oxide dispersed on the polymer.

More specifically, the cured product includes an olefin resin crosslinked by curing the olefinic monomer, and the olefin resin may be further crosslinked with the photocurable functional group of the amine compound. Further, on the olefin resin matrix having such a cross-linked structure, the above-mentioned metal oxide particles and, optionally, a dispersant and a component derived from a photopolymerization initiator and the like can be dispersed. However, most of the photopolymerization initiator is decomposed during the curing process, and thus may not substantially remain in the cured product and the optical member.

In such a cured product, the olefin resin is a polymer crosslinked from one or more olefinic monomers and the like, and the form thereof is not particularly limited, and can have various forms such as a homo copolymer, a block copolymer, a random copolymer, or a graft copolymer, depending on the type of the monomer and the mechanism of the polymerization reaction.

As the cured film including the cured product is formed of the photopolymerizable composition of an embodiment having a viscosity suitable for an inkjet application process, it can exhibit excellent heat resistance and mechanical properties, and good coating film properties. Further, the cured film may have a high refractive index of, for example, 1.6 or more, or 1.6 to 2.0, or 1.6 to 1.65, due to the interaction of the olefinic monomer and metal oxide particles, and it exhibits a high degree of surface curing due to the action of the amine compound, for example, a low haze of 3% or less, or 1% or less, or 0 to 1%, or 0.01 to 0.8%, or 0.1 to 0.3% and light transmittance such as excellent UV transmittance and visibility. In this case, the refractive index may mean a value measured with respect to a wavelength of 555 to 575 nm (average) using an ellipsometer.

In the above-mentioned optical member, a well-known substrate such as bare glass can be used as the substrate.

Further, the optical member can be produced by applying the photopolymerizable composition of the embodiment described above onto the substrate using a Mayer bar, a coating applicator, inkjet equipment, or like, for example, proceeding exposure and photographing using an LED lamp or a metal halide in an air atmosphere, LED lamp, metal halide or the like. At this time, the photopolymerizable composition may be applied in the form of a single film and then photocured to form an optical member in the form of a general optical film, and if necessary, it can be applied so as to have a certain pattern using the inkjet equipment and then photocured. In this case, the optical member may be in the form of a patterned film in which a cured film patterned in a form of polyhedron such as a prism structure is formed on a substrate.

The above-mentioned optical member such as an optical film or a pattern film may have a general thickness depending on the type or structure of the applied display device. For example, it may have a thickness controlled within the range of 0.01 μm to 1000 μm.

Further, the optical member may have a sensitivity value of 3 J or less, and a light transmittance of 90% or more. The sensitivity can be measured by comparing absorbance measurement results before and after exposure using an FT-IR spectrophotometer. More specifically, the conversion rate is obtained by integrating the C═O peak of 1650 to 1750 cm⁻¹ and the C═C peak of 780 to 880 cm⁻¹, and the sensitivity may mean an exposure amount that is saturated at a conversion rate of 80% or more. Further, the light transmittance may mean an average transmittance measured at a wavelength of 380 to 780 nm using a UV-VIS spectrophotometer for an optical member such as an optical film.

The optical film may have a 5 wt % loss temperature measured by TGA by increasing the temperature from room temperature to 900° C. at a rate of 10° C. per minute to be 270° C. or more, thereby exhibiting excellent heat resistance.

Since the above-mentioned optical member of another embodiment, such as the optical film or pattern film satisfies excellent optical properties, heat resistance, mechanical properties, and the like, it can be applied to various display devices and greatly contribute to the improvement of its characteristics.

Therefore, according to another embodiment of the present disclosure, a display device including the optical member is provided.

The configuration of the display device to which the optical member such as the optical film or the pattern film is applied can follow a conventional configuration well known in the art, except that the optical member of the other embodiments described above is applied, and therefore, an additional description thereof will be omitted.

Hereinafter, examples are presented to facilitate the understanding of the present disclosure. However, the following examples are for illustrative purposes only and the present disclosure is not limited thereto.

### Comparative Examples 1 to 3, Reference Examples 1 to 16, and Examples 1 to 54

### Preparation of Photopolymerizable Composition and Optical Film

First, each compound was mixed with the composition of the monomers shown in Tables 1 to 3 below to prepare the olefinic monomers used in the preparation of the photopolymerizable compositions of Examples, Reference Examples, and Comparative Examples, respectively. Further, in the composition of Tables 4 to 6 below, the olefinic monomer and the remaining components were mixed to prepare the photopolymerizable compositions of Comparative Examples, Reference Examples, and Examples, respectively.

Each composition was put into an inkjet device, and then applied to a bare glass to form a single film having a thickness of 20 μm.

Then, the single film was irradiated with an exposure amount of 1.5 J/cm² in an air atmosphere, using a belt type metal halide UV irradiation device (120 W/cm²) to which a 330 to 440 nm UV filter was applied, thereby preparing an optical film including a cured film of a photopolymerizable composition. At this time, the thickness of the cured film formed on the optical film was maintained at 20 μm.

The physical properties such as refractive index, haze and viscosity of each of the optical films of Comparative Examples and Examples were measured by the following method, and the results are shown in Tables 7 to 9 below.

### Method of Measuring Physical Properties of Optical Films

### 1) Sensitivity

The absorbance was measured before and after exposure using an FT-IR spectrophotometer, and the measurement results were compared. The conversion rate was obtained by integrating the C═O peak of 1650˜1750 cm⁻¹ and the C═C peak of 780˜880 cm⁻¹, and the sensitivity was measured and calculated as the amount of exposure that saturates when the conversion rate is 80% or more.

Evaluation Standard

∘: when the sensitivity value is 3 J or less

X: when the sensitivity value is greater than 3 J

### 2) Refractive Index

The refractive index (average 555˜575 nm) of the optical film was measured using an ellipsometer.

Evaluation Standard

∘: when the refractive index measurement value of the optical film is 1.6 or more

X: when the refractive index measurement value of the optical film is less than 1.6

### 3) Light Transmittance

The average transmittance of the optical film was measured at 380 to 780 nm using a UV-VIS spectrophotometer (Cary4000, Agilent).

Evaluation Standard

∘: when the average transmittance value is 90% or more

X: when the average transmittance value is less than 90%

### 4) Haze

The haze was measured using a haze meter COH 400 produced by NIPPON DENSHOKU.

Evaluation Standard

∘: when the haze measurement value is 1.0% or less

Δ: when the haze measurement value is greater than 1.0% and 3.0% or less

X: when the haze measurement value is greater than 3.0%

### 5) Viscosity (Absolute Viscosity)

The absolute viscosity of each of the photopolymerizable compositions and olefinic monomers of the Comparative Examples and Examples was measured using a viscometer (trade name: Brook Field viscometer) at a temperature of 25° C.

Evaluation Standard

∘: when the absolute viscosity value is 5 to 30 cP

X: when the absolute viscosity value is out of the above range

### 6) Inkjet Processability

It was confirmed whether the surface was formed by changing the nozzle temperature of the inkjet equipment.

Evaluation Standard

∘: Surface formation at nozzle temperature of 25 to 50° C.

X: No surface formation at nozzle temperature of 25 to 50° C.

### 7) Heat Resistance

Heat resistance was measured using a TGA device. The pattern film formed during the sensitivity measurement was sampled, and then measurement was performed while raising the temperature from room temperature to 900° C. at a rate of 10° C. per minute using TGA device. At this time, the TGA device used the device produced by TA Instruments.

Evaluation Standard

∘: TGA 5 wt % Weight loss Temp. Above 270° C.

X: TGA 5 wt % Weight loss Temp. Below 270° C.

TABLE 1

| | Monomer ratio (wt %) | | | | | | | | | |
|---|---|---|---|---|---|---|---|---|---|---|
| | | | | | | Phenoxy | | Dipropylene | Triethylene | Tripropylene |
| | Benzyl | Lauryl | isodecyl | Phenoxyethyl | Isobornyl | benzyl | Hexanediol | glycol | glycol | glycol |
| Example | acrylate | acrylate | acrylate | acrylate | acrylate | acrylate | diacrylate | diacrylate | diacrylate | diacrylate |
| No. | (2 cP) | (4 cP) | (5 cP) | (9 cP) | (8 cP) | (10 cP) | (12 cP) | (15 cP) | (20 cP) | (25 cP) |
| 1 | 100 | | | | | | | | | |
| 2 | 100 | | | | | | | | | |
| 3 | 100 | | | | | | | | | |
| 4 | 100 | | | | | | | | | |
| 5 | 100 | | | | | | | | | |
| 6 | | | | 100 | | | | | | |
| 7 | | 100 | | | | | | | | |
| 8 | | | 100 | | | | | | | |
| 9 | | | | 100 | | | | | | |
| 10 | | | | | 100 | | | | | |
| 11 | | | | | | 100 | | | | |
| 12 | | | | | | | 100 | | | |
| 13 | | | | 100 | | | | | | |
| 14 | | | | | 100 | | | | | |
| 15 | | | | | | 100 | | | | |
| 16 | | | | | | | 100 | | | |
| 17 | | | | | | | | 100 | | |
| 18 | | | | | | | | | 100 | |
| 19 | | | | | | | | | | 100 |
| 20 | | 40 | | 60 | | | | | | |
| 21 | | 40 | | 60 | | | | | | |
| 22 | | 40 | | 60 | | | | | | |
| 23 | | 40 | | 60 | | | | | | |
| 24 | | 40 | | 60 | | | | | | |
| 25 | | 40 | | 60 | | | | | | |
| 26 | | 40 | | 60 | | | | | | |
| 27 | | 40 | | 60 | | | | | | |
| 28 | | 40 | | 60 | | | | | | |
| 29 | | 30 | | 70 | | | | | | |
| 30 | | 20 | | 80 | | | | | | |
| 31 | | 40 | | 60 | | | | | | |
| 32 | | 30 | | 70 | | | | | | |
| 33 | | 20 | | 80 | | | | | | |
| 34 | | 40 | | 60 | | | | | | |
| 35 | | 30 | | 70 | | | | | | |
| 36 | | 20 | | 80 | | | | | | |
| 37 | | 20 | | 80 | | | | | | |

TABLE 2

| | Monomer ratio (wt %) | | | | | | | |
|---|---|---|---|---|---|---|---|---|
| | | | | | | | Phenoxy | |
| Example (or | Methyl | Benzyl | Lauryl | isodecyl | Phenoxyethyl | Isobornyl | benzyl | Hexanediol |
| Comparative | acrylate | acrylate | acrylate | acrylate | acrylate | acrylate | acrylate | diacrylate |
| Example) No. | (0.5 cP) | (2 cP) | (4 cP) | (5 cP) | (9 cP) | (8 cP) | (10 cP) | (12 cP) |
| 38 | | 100 | | | | | | |
| 39 | | | 20 | | 80 | | | |
| 40 | | | 20 | | 80 | | | |
| 41 | | | 20 | | 80 | | | |
| 42 | | | 20 | | 80 | | | |
| 43 | | 20 | | | 80 | | | |
| 44 | | 20 | | | | 80 | | |
| 45 | | 20 | | | | | 80 | |
| 46 | | 20 | | | | | | 80 |
| 47 | | | 20 | | | 80 | | |
| 48 | | | 20 | | | | 80 | |
| 49 | | | 20 | | | | | 80 |
| 50 | | | | 20 | 80 | | | |
| 51 | | | | 20 | | 80 | | |
| 52 | | | | 20 | | | 80 | |
| 53 | | | | 20 | | | | 80 |
| 54 | | 20 | | | | 80 | | |
| Comparative | | 40 | | | 60 | | | |
| Example 1 | | | | | | | | |
| Comparative | | 40 | | | 60 | | | |
| Example 2 | | | | | | | | |
| Comparative | | 40 | | | 60 | | | |
| Example 3 | | | | | | | | |

TABLE 3

| | Monomer ratio (wt %) | | | | |
|---|---|---|---|---|---|
| Referemce | Methyl | Lauryl | Phenoxyethyl | Isobornyl | Biphenylmethyl |
| Example | acrylate | acrylate | acrylate | acrylate | acrylate |
| No. | (0.5 cP) | (4 cP) | (9 cP) | (8 cP) | (40 cP) |
| 1 | | 20 | | 80 | |
| 2 | | 20 | | 80 | |
| 3 | | 20 | | 80 | |
| 4 | | 20 | | 80 | |
| 5 | | 20 | | 80 | |
| 6 | 100 | | | | |
| 7 | | | | | 100 |
| 8 | 100 | | | | |
| 9 | 20 | | | | 80 |
| 10 | 80 | | | | 20 |
| 11 | | 40 | 60 | | |
| 12 | | 40 | 60 | | |
| 13 | | 40 | 60 | | |
| 14 | | 40 | 60 | | |
| 15 | | 40 | 60 | | |
| 16 | | 40 | 60 | | |

TABLE 4

| | Metal oxide | | | | | | | | | | | | | | | |
|---|---|---|---|---|---|---|---|---|---|---|---|---|---|---|---|---|
| | (ZrO₂) | | | | | | | | | | | | | | | |
| | Average | | | | | | | | | | | | | | | |
| | particle | | | | Photopolymerization initiator | | | | | | | Amine compound | | | | |
| | size | Content | Dispersant | Monomer | (wt %) | | | | | | | (wt %) | | | | |
| Category | (D50; nm) | (wt %) | (wt %) | (wt %) | A | B | C | D | E | F | G | A | B | C | D | E |
| Example 1 | 30 | 65 | 6 | 21 | 5 | | | | | | | 3 | | | | |
| Example 2 | 30 | 60 | 6 | 26 | | 5 | | | | | | | 3 | | | |
| Example 3 | 30 | 55 | 5.5 | 31.5 | | | 5 | | | | | | | 3 | | |
| Example 4 | 30 | 50 | 5 | 37 | | | | 5 | | | | | | | 3 | |
| Example 5 | 30 | 40 | 4 | 48 | | | | | 5 | | | | | | | 3 |
| Example 6 | 30 | 10 | 1 | 81 | | | | | | 5 | | 3 | | | | |
| Example 7 | 30 | 50 | 5 | 37 | | | | | | | 5 | | 3 | | | |
| Example 8 | 30 | 50 | 5 | 37 | 5 | | | | | | | | | 3 | | |
| Example 9 | 30 | 50 | 5 | 37 | | 5 | | | | | | | | | 3 | |
| Example 10 | 30 | 50 | 5 | 37 | | | 5 | | | | | | | | | 3 |
| Example 11 | 30 | 50 | 5 | 37 | | | | 5 | | | | 3 | | | | |
| Example 12 | 30 | 50 | 5 | 37 | | | | | 5 | | | | 3 | | | |
| Example 13 | 35 | 40 | 4 | 48 | | | | | | 5 | | | | 3 | | |
| Example 14 | 35 | 40 | 4 | 48 | | | | | | | 5 | | | | 3 | |
| Example 15 | 35 | 40 | 4 | 48 | 5 | | | | | | | | | | | 3 |
| Example 16 | 35 | 40 | 4 | 48 | | 5 | | | | | | 3 | | | | |
| Example 17 | 35 | 40 | 4 | 48 | | | 5 | | | | | | 3 | | | |
| Example 18 | 35 | 40 | 4 | 48 | | | | 5 | | | | | | 3 | | |
| Example 19 | 35 | 40 | 4 | 48 | | | | | 5 | | | | | | 3 | |
| Example 20 | 30 | 40 | 5 | 52 | | | | | | 5 | | | | | | 3 |
| Example 21 | 30 | 40 | 5 | 52 | | | | | | | 5 | | 3 | | | |
| Example 22 | 30 | 40 | 5 | 47 | 5 | | | | | | | | | 3 | | |
| Example 23 | 30 | 40 | 5 | 47 | | 5 | | | | | | | | | 3 | |
| Example 24 | 30 | 40 | 5 | 47 | | | 5 | | | | | | | | | 3 |
| Example 25 | 30 | 40 | 5 | 49.5 | | | | 5 | | | | 0.5 | | | | |
| Example 26 | 30 | 40 | 5 | 45 | | | | | 5 | | | 5 | | | | |
| Example 27 | 30 | 35 | 5 | 47 | | | | | | 5 | | 8 | | | | |
| Example 28 | 30 | 35 | 5 | 52 | | | | | | | 5 | 1 | | | 2 | |
| Example 29 | 30 | 50 | 5 | 37 | 5 | | | | | | | 3 | | | | |
| Example 30 | 30 | 50 | 5 | 37 | | 5 | | | | | | | 3 | | | |
| Example 31 | 30 | 35 | 3.5 | 53.5 | | | 5 | | | | | | | 3 | | |
| Example 32 | 30 | 35 | 3.5 | 53.5 | | | | 5 | | | | | | | 3 | |
| Example 33 | 30 | 35 | 3.5 | 53.5 | | | | | 5 | | | | | | | 3 |
| Example 34 | 30 | 35 | 3.5 | 43.5 | 15 | | | | | | | 3 | | | | |
| Example 35 | 30 | 35 | 3.5 | 43.5 | 15 | | | | | | | | 3 | | | |
| Example 36 | 30 | 35 | 3.5 | 43.5 | 15 | | | | | | | | | 3 | | |
| Example 37 | 30 | 35 | 3.5 | 28.5 | 30 | | | | | | | | | | 3 | |

Note)
Type of photopolymerization initiator
A: [1-[9-ethyl-6-(2-methylbenzoyl)-9H-carbazolyl-3-yl]-1-(O-acetyloxime)
B: OXE-01
C: Darocure TPO
D: E)-2-(acetoxyimino)-1-(9,9-diethyl-9H-fluorene-2-yl)butanone
E: Irgacure 819
F: Irgacure 369
G: Irgacure 907
Note)
Type of amine compound
A: ethyl dimethylamino benzoate
B: butoxyethyl dimethylamino benzoate
C: diethylaminoethyl (meth)acrylate
D: P115 (produced by SK Cytec)
E: MIRAMER AS2010 (produced by Miwon Specialty Chemical)
Note)
Dispersant: Dispersant containing acryl-based polymer (commercially available product)

TABLE 5

| | Metal oxide¹⁾ | | | | | | | | | | | | | | | |
|---|---|---|---|---|---|---|---|---|---|---|---|---|---|---|---|---|
| | Average | | | | | | | | | | | | | | | |
| | particle | | | | Photopolymerization initiator | | | | | | | Amine compound | | | | |
| | size | Content | Dispersant | Monomer | (wt %) | | | | | | | (wt %) | | | | |
| Category | (D50; nm) | (wt %) | (wt %) | (wt %) | A | B | C | D | E | F | G | A | B | C | D | E |
| Example 38 | 30 | 60 | 6 | 30 | 1 | | | | | | | 3 | | | | |
| Example 39 | 37 | 50 | 5 | 37 | | 5 | | | | | | | 3 | | | |
| Example 40 | 37 | 50 | 5 | 37 | | | 5 | | | | | | | 3 | | |
| Example 41 | 37 | 50 | 5 | 37 | | | | 5 | | | | | | | 3 | |
| Example 42 | 37 | 50 | 5 | 37 | | | | | 5 | | | | | | | 3 |
| Example 43 | 30 | 50 | 5 | 37 | 5 | | | | | | | 3 | | | | |
| Example 44 | 30 | 50 | 5 | 37 | | 5 | | | | | | | 3 | | | |
| Example 45 | 30 | 50 | 5 | 37 | | | 5 | | | | | | | 3 | | |
| Example 46 | 30 | 50 | 5 | 37 | | | | 5 | | | | | | | 3 | |
| Example 47 | 30 | 50 | 5 | 37 | | | | | 5 | | | | | | | 3 |
| Example 48 | 30 | 50 | 5 | 42 | | | | | | 5 | | 3 | | | | |
| Example 49 | 30 | 50 | 5 | 42 | | | | | | | 5 | | 3 | | | |
| Example 50 | 40 | 50 | 5 | 37 | 5 | | | | | | | | | 3 | | |
| Example 51 | 40 | 50 | 5 | 37 | | 5 | | | | | | | | | 3 | |
| Example 52 | 40 | 50 | 5 | 37 | | | 5 | | | | | | | | | 3 |
| Example 53 | 40 | 50 | 5 | 37 | | | | 5 | | | | 3 | | | | |
| Example 54 | 40 | 50 | 5 | 37 | | | | | 5 | | | | 3 | | | |
| Comparative | 30 | 35 | 5 | 55 | | 5 | | | | | | | | | | |
| Example 1 | | | | | | | | | | | | | | | | |
| Comparative | 30 | 40 | 5 | 50 | | | 5 | | | | | | | | | |
| Example 2 | | | | | | | | | | | | | | | | |
| Comparative | 30 | 50 | 5 | 40 | | | | 5 | | | | | | | | |
| Example 3 | | | | | | | | | | | | | | | | |

Note
¹⁾Metal oxide particles: Examples and Comparative Examples 1-3 all use ZrO₂.
Note)
The types of photopolymerization initiator, amine compound and dispersant are the same as Note) in Table 4.]

TABLE 6

| | Metal oxide¹⁾ | | | | | | | | | | | | | | | |
|---|---|---|---|---|---|---|---|---|---|---|---|---|---|---|---|---|
| | Average | | | | | | | | | | | | | | | |
| | particle | | | | Photopolymerization initiator | | | | | | | Amine compound | | | | |
| | size | Content | Dispersant | Monomer | (wt %) | | | | | | | (wt %) | | | | |
| Category | (D50; nm) | (wt %) | (wt %) | (wt %) | A | B | C | D | E | F | G | A | B | C | D | E |
| Reference | 7 | 50 | 5 | 37 | | | | | | 5 | | | | 3 | | |
| Example 1 | | | | | | | | | | | | | | | | |
| Reference | 20 | 50 | 5 | 37 | | | | | | | 5 | | | | 3 | |
| Example 2 | | | | | | | | | | | | | | | | |
| Reference | 50 | 50 | 5 | 37 | 5 | | | | | | | | | | | 3 |
| Example 3 | | | | | | | | | | | | | | | | |
| Reference | 80 | 50 | 5 | 37 | | 5 | | | | | | 3 | | | | |
| Example 4 | | | | | | | | | | | | | | | | |
| Reference | 100 | 50 | 5 | 37 | | | 5 | | | | | | 3 | | | |
| Example 5 | | | | | | | | | | | | | | | | |
| Reference | 30 | 50 | 5 | 37 | | | | 5 | | | | | | 3 | | |
| Example 6 | | | | | | | | | | | | | | | | |
| Reference | 30 | 50 | 5 | 37 | | | | | 5 | | | | | | 3 | |
| Example 7 | | | | | | | | | | | | | | | | |
| Reference | 30 | 35 | 4 | 53 | | | | | | 5 | | | | | | 3 |
| Example 8 | | | | | | | | | | | | | | | | |
| Reference | 30 | 45 | 5 | 42 | | | | | | | 5 | 3 | | | | |
| Example 9 | | | | | | | | | | | | | | | | |
| Reference | 30 | 50 | 5 | 37 | 5 | | | | | | | | 3 | | | |
| Example 10 | | | | | | | | | | | | | | | | |
| Reference | 30 | 42.95 | 5 | 47 | | | | | 5 | | | 0.05 | | | | |
| Example 11 | | | | | | | | | | | | | | | | |
| Reference | 30 | 35 | 5 | 44 | | | | | | 5 | | 11 | | | | |
| Example 12 | | | | | | | | | | | | | | | | |
| Reference | TiO2 20 | 35 | 5 | 52 | | | | | | | 5 | 3 | | | | |
| Example 13 | | | | | | | | | | | | | | | | |
| Reference | TiO2 50 | 40 | 5 | 47 | 5 | | | | | | | | 3 | | | |
| Example 14 | | | | | | | | | | | | | | | | |
| Reference | ZnO 20 | 40 | 5 | 47 | | 5 | | | | | | | | 3 | | |
| Example 15 | | | | | | | | | | | | | | | | |
| Reference | ZnO 50 | 40 | 5 | 47 | | | 5 | | | | | | | | 3 | |
| Example 16 | | | | | | | | | | | | | | | | |

Note
¹⁾Metal oxide particles: Reference Examples 1 to 13 all use ZrO₂. Reference Examples 14 to 16 are listed separately for each composition.
Note)
The types of photopolymerization initiator, amine compound and dispersant are the same as Note) in Table 4.

TABLE 7

| | | Refractive | | | Absolute | Inkjet | Heat |
|---|---|---|---|---|---|---|---|
| Category | Sensitivity | index | Transmittance | Haze | viscosity | processability | resistance |
| Example 1 | ◯ | ◯ | ◯ | ◯ | ◯ | ◯ | ◯ |
| Example 2 | ◯ | ◯ | ◯ | ◯ | ◯ | ◯ | ◯ |
| Example 3 | ◯ | ◯ | ◯ | ◯ | ◯ | ◯ | ◯ |
| Example 4 | ◯ | ◯ | ◯ | ◯ | ◯ | ◯ | ◯ |
| Example 5 | ◯ | ◯ | ◯ | ◯ | ◯ | ◯ | ◯ |
| Example 6 | ◯ | ◯ | ◯ | ◯ | ◯ | ◯ | ◯ |
| Example 7 | ◯ | ◯ | ◯ | ◯ | ◯ | ◯ | ◯ |
| Example 8 | ◯ | ◯ | ◯ | ◯ | ◯ | ◯ | ◯ |
| Example 9 | ◯ | ◯ | ◯ | ◯ | ◯ | ◯ | ◯ |
| Example 10 | ◯ | ◯ | ◯ | ◯ | ◯ | ◯ | ◯ |
| Example 11 | ◯ | ◯ | ◯ | ◯ | ◯ | ◯ | ◯ |
| Example 12 | ◯ | ◯ | ◯ | ◯ | ◯ | ◯ | ◯ |
| Example 13 | ◯ | ◯ | ◯ | ◯ | ◯ | ◯ | ◯ |
| Example 14 | ◯ | ◯ | ◯ | ◯ | ◯ | ◯ | ◯ |
| Example 15 | ◯ | ◯ | ◯ | ◯ | ◯ | ◯ | ◯ |
| Example 16 | ◯ | ◯ | ◯ | ◯ | ◯ | ◯ | ◯ |
| Example 17 | ◯ | ◯ | ◯ | ◯ | ◯ | ◯ | ◯ |
| Example 18 | ◯ | ◯ | ◯ | ◯ | ◯ | ◯ | ◯ |
| Example 19 | ◯ | ◯ | ◯ | ◯ | ◯ | ◯ | ◯ |
| Example 20 | ◯ | ◯ | ◯ | ◯ | ◯ | ◯ | ◯ |
| Example 21 | ◯ | ◯ | ◯ | ◯ | ◯ | ◯ | ◯ |
| Example 22 | ◯ | ◯ | ◯ | ◯ | ◯ | ◯ | ◯ |
| Example 23 | ◯ | ◯ | ◯ | ◯ | ◯ | ◯ | ◯ |
| Example 24 | ◯ | ◯ | ◯ | ◯ | ◯ | ◯ | ◯ |
| Example 25 | ◯ | ◯ | ◯ | ◯ | ◯ | ◯ | ◯ |
| Example 26 | ◯ | ◯ | ◯ | ◯ | ◯ | ◯ | ◯ |
| Example 27 | ◯ | ◯ | ◯ | ◯ | ◯ | ◯ | ◯ |
| Example 28 | ◯ | ◯ | ◯ | ◯ | ◯ | ◯ | ◯ |
| Example 29 | ◯ | ◯ | ◯ | ◯ | ◯ | ◯ | ◯ |
| Example 30 | ◯ | ◯ | ◯ | ◯ | ◯ | ◯ | ◯ |
| Example 31 | ◯ | ◯ | ◯ | ◯ | ◯ | ◯ | ◯ |
| Example 32 | ◯ | ◯ | ◯ | ◯ | ◯ | ◯ | ◯ |
| Example 33 | ◯ | ◯ | ◯ | ◯ | ◯ | ◯ | ◯ |
| Example 34 | ◯ | ◯ | ◯ | ◯ | ◯ | ◯ | ◯ |
| Example 35 | ◯ | ◯ | ◯ | ◯ | ◯ | ◯ | ◯ |
| Example 36 | ◯ | ◯ | ◯ | ◯ | ◯ | ◯ | ◯ |
| Example 37 | ◯ | ◯ | ◯ | ◯ | ◯ | ◯ | ◯ |

TABLE 8

| | | Refractive | | | | Inkjet | Heat |
|---|---|---|---|---|---|---|---|
| Category | Sensitivity | index | Transmittance | Haze | Viscosity | processability | resistance |
| Example 38 | ◯ | ◯ | ◯ | ◯ | ◯ | ◯ | ◯ |
| Example 39 | ◯ | ◯ | ◯ | ◯ | ◯ | ◯ | ◯ |
| Example 40 | ◯ | ◯ | ◯ | ◯ | ◯ | ◯ | ◯ |
| Example 41 | ◯ | ◯ | ◯ | ◯ | ◯ | ◯ | ◯ |
| Example 42 | ◯ | ◯ | ◯ | ◯ | ◯ | ◯ | ◯ |
| Example 43 | ◯ | ◯ | ◯ | ◯ | ◯ | ◯ | ◯ |
| Example 44 | ◯ | ◯ | ◯ | ◯ | ◯ | ◯ | ◯ |
| Example 45 | ◯ | ◯ | ◯ | ◯ | ◯ | ◯ | ◯ |
| Example 46 | ◯ | ◯ | ◯ | ◯ | ◯ | ◯ | ◯ |
| Example 47 | ◯ | ◯ | ◯ | ◯ | ◯ | ◯ | ◯ |
| Example 48 | ◯ | ◯ | ◯ | ◯ | ◯ | ◯ | ◯ |
| Example 49 | ◯ | ◯ | ◯ | ◯ | ◯ | ◯ | ◯ |
| Example 50 | ◯ | ◯ | ◯ | ◯ | ◯ | ◯ | ◯ |
| Example 51 | ◯ | ◯ | ◯ | ◯ | ◯ | ◯ | ◯ |
| Example 52 | ◯ | ◯ | ◯ | ◯ | ◯ | ◯ | ◯ |
| Example 53 | ◯ | ◯ | ◯ | ◯ | ◯ | ◯ | ◯ |
| Example 54 | ◯ | ◯ | ◯ | ◯ | ◯ | ◯ | ◯ |
| Comparative | ◯ | ◯ | ◯ | X | ◯ | ◯ | ◯ |
| Example 1 | | | | | | | |
| Comparative | ◯ | ◯ | ◯ | X | ◯ | ◯ | ◯ |
| Example 2 | | | | | | | |
| Comparative | ◯ | ◯ | ◯ | X | ◯ | ◯ | ◯ |
| Example 3 | | | | | | | |

TABLE 9

| | | Refractive | | | | Inkjet | Heat |
|---|---|---|---|---|---|---|---|
| Category | Sensitivity | index | Transmittance | Haze | Viscosity | processibility | resistance |
| Reference | ◯ | ◯ | ◯ | Δ | X | ◯ | ◯ |
| Example 1 | | | | | | | |
| Reference | ◯ | ◯ | ◯ | Δ | X | ◯ | ◯ |
| Example 2 | | | | | | | |
| Reference | ◯ | ◯ | ◯ | Δ | ◯ | ◯ | ◯ |
| Example 3 | | | | | | | |
| Reference | ◯ | ◯ | ◯ | Δ | ◯ | ◯ | ◯ |
| Example 4 | | | | | | | |
| Reference | ◯ | ◯ | ◯ | Δ | ◯ | ◯ | ◯ |
| Example 5 | | | | | | | |
| Reference | ◯ | ◯ | ◯ | Δ | X | X | X |
| Example 6 | | | | | | | |
| Reference | ◯ | ◯ | ◯ | Δ | X | X | ◯ |
| Example 7 | | | | | | | |
| Reference | ◯ | ◯ | ◯ | Δ | X | X | ◯ |
| Example 8 | | | | | | | |
| Reference | ◯ | ◯ | ◯ | Δ | X | X | X |
| Example 9 | | | | | | | |
| Reference | ◯ | ◯ | ◯ | Δ | ◯ | ◯ | ◯ |
| Example 10 | | | | | | | |
| Reference | ◯ | ◯ | ◯ | Δ | ◯ | ◯ | ◯ |
| Example 11 | | | | | | | |
| Reference | ◯ | ◯ | ◯ | Δ | X | ◯ | ◯ |
| Example 12 | | | | | | | |
| Reference | ◯ | ◯ | ◯ | Δ | ◯ | ◯ | ◯ |
| Example 13 | | | | | | | |
| Reference | ◯ | ◯ | ◯ | Δ | ◯ | ◯ | ◯ |
| Example 14 | | | | | | | |
| Reference | ◯ | ◯ | ◯ | Δ | ◯ | ◯ | ◯ |
| Example 15 | | | | | | | |
| Reference | ◯ | ◯ | ◯ | Δ | ◯ | ◯ | ◯ |
| Example 16 | | | | | | | |

Looking at the results of Tables 7 and 8, it was confirmed that Examples 1 to 54 exhibit a low haze while having good refractive index and viscosity as compared with Comparative Examples 1 to 3. Further, it is considered that as compared with Comparative Examples, Examples have excellent sensitivity, transmittance, and heat resistance as well as processability by an inkjet application process, and thus can contribute to the improvement of performance when applied as an optical member in a display device.

Meanwhile, it was confirmed that Reference Examples 1 to 16 of Table 9 exhibit lower than those of Comparative Examples, and are applicable to forming an optical member of a display device.

1. A photopolymerizable composition comprising:
at least one olefinic, monomer having a photocurable functional group;
metal oxide particles;
an amine compound having an amine group and a photocurable functional group; and
a photopolymerization initiator.

2. The photopolymerizable composition of claim 1, wherein the photocurable functional group of the olefinic monomer or the amine compound comprises a (meth)acrylate group.

3. The photopolymerizable composition of claim 1, wherein the olefinic monomer comprises at least one selected from the group consisting of an aliphatic mono(meth)acrylate having 6 to 20 carbon atoms, an alicyclic mono(meth)acrylate having 6 to 30 carbon atoms, an aromatic mono(meth)acrylate having 8 to 30 carbon atoms, an aliphatic di(meth)acrylate having 6 to 30 carbon atoms, an alicyclic di(meth)acrylate having 6 to 40 carbon atoms, and an aromatic di(meth)acrylate having 8 to 40 carbon atoms.

4. The photopolymerizable composition of claim 1, wherein the olefinic monomer comprises a monomer having an absolute viscosity, which is measured at 25° C., of 1 cP to 30 cP.

5. The photopolymerizable composition of claim 4, wherein the olefinic monomer comprises at least one selected from the group consisting of a first olefinic monomer having an absolute viscosity, measured at 25° C., of 1 cP or more and 7 cP or less and a second olefinic monomer having an absolute viscosity, measured at 25° C., of 8 cP or more and 30 cP or less.

6. The photopolymerizable composition of claim 5, wherein the first olefinic monomer comprises at least one selected from the group consisting of benzyl(meth)acrylate, isodecyl(meth)acrylate, lauryl(meth)acrylate, ethoxy ethyl(meth)acrylate, dicyclopentenyl (meth)acrylate, and dicyclopentanyl(meth)acrylate.

7. The photopolymerizable composition of claim 5, wherein the second olefinic monomer comprises at least one selected from the group consisting of dicyclopentenyl oxy ethyl(meth)acrylate, phenoxy ethyl(meth)acrylate, phenoxy benzyl(meth)acrylate, isobornyl (meth)acrylate, 1,6-hexanediol di(meth)acrylate, triethylene glycol di(meth)acrylate, tetraethylene glycoldi(meth)acrylate, dipropylene glycol di(meth)acrylate, 2-vinyloxyethoxy ethyl(meth)acrylate, and tripropylene glycol di(meth)acrylate.

8. The photopolymerizable composition of claim 5, wherein the olefinic monomer contains the first olefinic monomer by 10 to 90 parts by weight and the second olefinic monomer by 10 to 90 parts by weight.

9. The photopolymerizable composition of claim 1, wherein the metal oxide particles have an average particle size (D50) of 25 to 45 nm based on the secondary particle size in a medium-dispersed state, and comprises a metal element selected from the group consisting of Zn, Zr, Ti, Hf, and Ce.

10. The photopolymerizable composition of claim 1, wherein the amine compound comprises at least one selected from the group consisting of a compound of the following Chemical Formula 1, ethyl dimethylamino benzoate, butoxyethyl dimethylamino benzoate, bis(diethylamino)benzophenone, bis(2-hydroethyl)-toluidine, ethylhexyl-(dimethylamino)benzoate, 2-(dimethylamino)ethyl (meth)acrylate, diethylaminoethyl(meth)acrylate, 2-(diisopropylamino)ethyl (meth)acrylate, 2-(acryloyloxy)ethyl 4-(dimethylamino)benzoate, 2-ethylhexyl 4-(dimethylamino)benzoate, ethyl 2-(dibutylamino)methyl acrylate, and 4,4-(oxybis(ethane-2, 1-diyl))bis(oxy)bis(dimethylaniline), 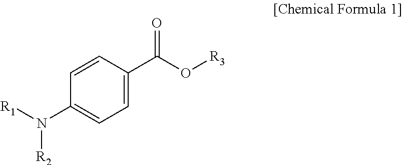
wherein, in Chemical Formula 1, R₁ and R₂ each independently represent an alkyl group having 1 to 5 carbon atoms, and R₃ represents an alkyl group having 1 to 20 carbon atoms, an ether group having 1 to 20 carbon atoms, an aryl group, an amine group or a (meth)acrylate group having 6 to 30 carbon atoms.

11. The photopolymerizable composition of claim 1, wherein the photopolymerization initiator comprises at least one selected from the group consisting of triazine-based, benzoin-based, benzophenone-based, imidazole-based, xanthone-based, oxime ester-based, and acetophenone-based compounds.

12. The photopolymerizable composition of claim 1, further comprising at least one dispersant selected from the group consisting of an acryl-based dispersant, an epoxy-based dispersant, and a silicone-based dispersant.

13. The photopolymerizable composition of claim 12, wherein the composition contains:
the olefinic monomer by 5% to 88% by weight,
the metal oxide particles by 10% to 70% by weight,
the amine compound by 0.1% to 10% by weight,
the dispersant by 0.1 parts to 30% by weight, and
the photopolymerization initiator by 0.1% to 10% by weight.

14. The photopolymerizable composition of claim 1, wherein the absolute viscosity, which is measured at 25° C., is 5 cP to 30 cP.

15. An optical member comprising:
a substrate; and
a cured film containing a cured product of the photopolymerizable composition of claim 1.

16. The optical member of claim 15, wherein the cured product comprises a polymer that contains a unit in which the photocurable functional groups of the olefinic monomer and the amine compound are crosslinked, and a dispersant dispersed on the polymer, and a metal oxide.

17. The optical member of claim 15, wherein the cured film has a refractive index equal to or greater than 1.6 and a haze equal to or less than 3%.

18. The optical member of claim 15, wherein the optical member is used as an optical film.

19. The optical member of claim 15, wherein the cured film is patterned in a form of polyhedron.

20. A display device comprising the optical member of claim 15.
